(19) United States
(12) Patent Application Publication
(10) Pub. No.: US 2019/0325294 A1
(43) Pub. Date: Oct. 24, 2019

(54) RECURRENT NEURAL NETWORK MODEL COMPACTION

(71) Applicant: QUALCOMM Incorporated, San Diego, CA (US)

(72) Inventors: Rosario CAMMAROTA, San Diego, CA (US); Manu RASTOGI, San Diego, CA (US)

(21) Appl. No.: 15/956,696

(22) Filed: Apr. 18, 2018

(51) Int. Cl. G06N 3/063; G06N 3/04

(52) U.S. Cl. CPC G06N 3/063; G06N 3/04

(57) ABSTRACT

An apparatus for operating a computational network, such as a long short term memory, is configured to compute in a first cell, an input for a cell of a next layer based on a prior hidden state and a current input. A memory state may be computed for the first cell based on a prior memory state, the prior hidden state, and the current input. The first cell outputs the computed input to the next layer cell, which may also receive a second prior memory state, a second prior hidden state. In turn, the next layer cell computes an input for a subsequent layer cell based on the second prior hidden state and the input supplied by the first cell in parallel with the first cell computing a hidden state and a memory state to be supplied to a subsequent cell in the same layer.

### BACKGROUND

### Field

Certain aspects of the present disclosure generally relate to machine learning and, more particularly, to improving systems and methods of compacting processing of a neural network model.

### Background

An artificial neural network, which may include an interconnected group of artificial neurons (e.g., neuron models), is a computational device or represents a method to be performed by a computational device.

Convolutional neural networks are a type of feed-forward artificial neural network. Convolutional neural networks may include collections of neurons that each has a receptive field and that collectively tile an input space.

Recurrent Neural Networks (RNNs) are similar to CNNs but are configured with a feedback connection. The recurrent connections may span adjacent time steps thereby giving the model a time concept. RNNs may take as inputs a current input or sample, as well as its output. The processing of the current input may influenced by information processed at a prior time. As such, RNNs may be useful in the area of pattern recognition, speech recognition and sequence detection, for example.

Deep learning architectures, such as deep convolutional networks and RNNs, are layered neural networks architectures in which the output of a first layer of neurons becomes an input to a second layer of neurons, the output of a second layer of neurons becomes and input to a third layer of neurons, and so on.

A RNN may be configured as a long-short term memory (LSTM) which preserves an error (e.g., classification error) and enables learning of long term dependencies. Accordingly, RNNs may trained to recognize a hierarch of features.

Unfortunately, RNNs may be large networks and the computational complexity and the time to compute an inference may be prohibitively high.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The features, which are believed to be characteristic of the disclosure, both as to its organization and method of operation, will be better understood from the following description when considered in connection with the accompanying figures. It is to be expressly understood, however, that each of the figures is provided for the purpose of illustration and description only and is not intended as a definition of the limits of the present disclosure.

A RNN is a class of architectures in which interconnected cells are configured to detect a pattern in a sequence of data. A LSTM is a type of RNN that enables learning of long term dependencies. Each cell may be configured to remember values over an arbitrary period of time t. As such, a RNN/LSTM may be useful for speech recognition and sequence detection tasks, for example. However, such networks may be large and the time to compute an inference may be prohibitively high.

To address the issues related to performance and completion time, a computational network may be accelerated by concurrently executing cells of the RNN/LSTM.

In an aspect of the disclosure, a method, a computer readable medium, and apparatus for operating a computational network are provided. The apparatus includes a memory and at least one processor coupled to the memory. The processor(s) being configured to compute, for a cell_{i,j}, an input x_{i,j+1} based on a hidden state h_{i-1,j} and an input x_{i,j}. The processor(s) are also configured to compute, for the cell_{i,j}, a memory state c_{i,j} based on a memory state c_{i-1,j}, the hidden state h_{i-1,j}, and the input x_{i,j} and configured to output, for the cell_{i,j}, the input x_{i,j+1} to a cell_{i,j+1}. Additionally, the processor(s) are configured to receive, by the cell_{i,j+1}, a memory state c_{i-1,j+1}, a hidden state h_{i-1,j+1}, and the input x_{i,j+1}. The processor(s) are also configured to compute in parallel, for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}. The processor(s) are further configured to output, for the cell_{i,j}, the memory state c_{i,j} and the hidden state h_{i,j} to a cell_{i+1,j}.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The features will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a block diagram illustrating an exemplary architecture of a recurrent neural network in the form of a long short-term memory (RNN/LSTM) in accordance with aspects of the present disclosure.

FIG. 3B is a diagram illustrating the processing flow of an exemplary RNN/LSTM using a straight model execution approach.

FIG. 3C, is a diagram illustrating the processing flow of an exemplary RNN/LSTM using a hyperplane execution approach.

FIG. 4 is a block diagram illustrating a bidirectional cells of an RNN/LSTM in accordance with aspects of the present disclosure.

FIG. 5 is a block diagram illustrating an exemplary software architecture that may modularize artificial intelligence (AI) functions in accordance with aspects of the present disclosure.

FIGS. 6A-D illustrates an exemplary method of operating a computational network according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description. The detailed description and drawings are merely illustrative of the disclosure rather than limiting, the scope of the disclosure being defined by the appended claims and equivalents thereof.

### Recurrent Neural Network Model Compaction

The present disclosure is directed to accelerating the execution of a recurrent neural network (RNN)/long short-term memory (LSTM) model and to reducing its completion time or time to determine an inference.

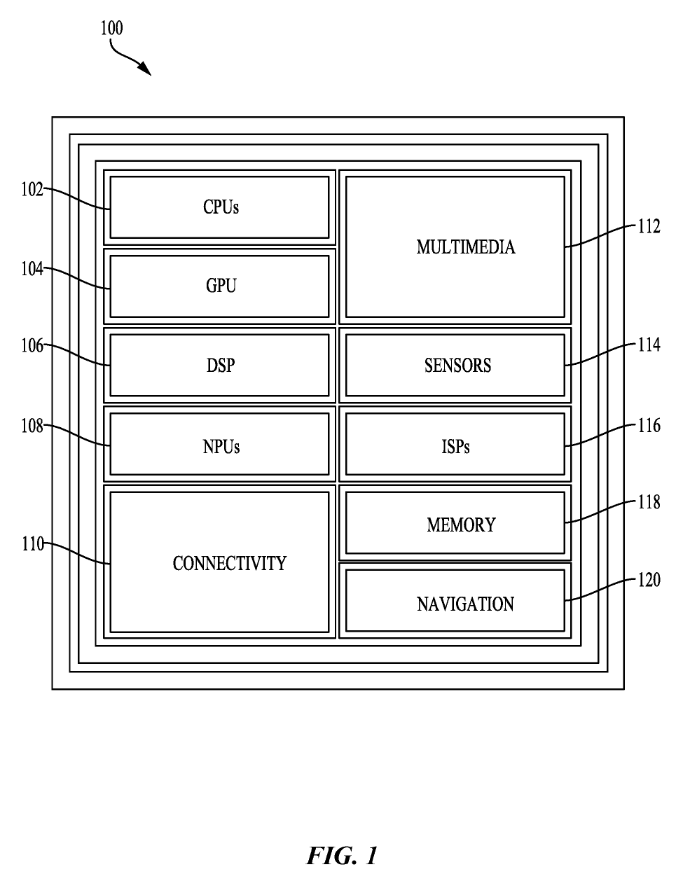

FIG. 1 illustrates an example implementation of acceleration of a computational network such as an RNN/LSTM model using a system-on-a-chip (SOC) 100, which may include a general-purpose processor (CPU) or multi-core general-purpose processors (CPUs) 102 in accordance with certain aspects of the present disclosure. Variables (e.g., weights or intermediate cell variables), system parameters associated with a computational device (e.g., cell states), delays, frequency bin information, and task information may be stored in a memory block associated with a Neural Processing Unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fifth generation wireless system (5G) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may include code for computing, by a first processor for a cell_{i,j}, an input x_{i,j+1} based on a hidden state h_{i-1,j} and an input x_{i,j}. The instructions loaded into the general-purpose processor 102 may also include code for computing, by the first processor for the cell_{i,j}, a memory state c_{i,j} based on a memory state c_{i-1,j}, the hidden state h_{i-1,j}, and the input x_{i,j} and for receiving, by the cell_{i,j+1}, a memory state c_{i-1,j+1}, a hidden state h_{i-1,j+1}, and the input x_{i,j+1}. Additionally, the instructions loaded into the general-purpose processor 102 may include code for computing in parallel, by a second processor for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}. The instructions loaded into the general-purpose processor 102 may further include code for outputting, by the first processor for the cell_{i,j}, the memory state c_{i,j} and the hidden state h_{i,j} to a cell_{i+1,j}.

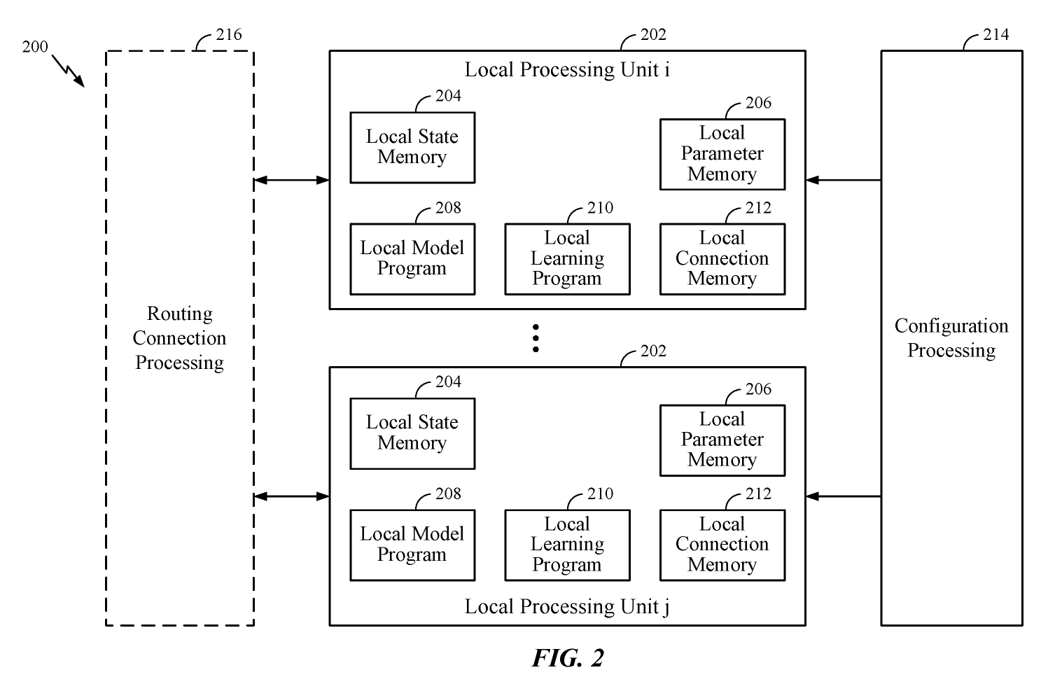

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may include a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

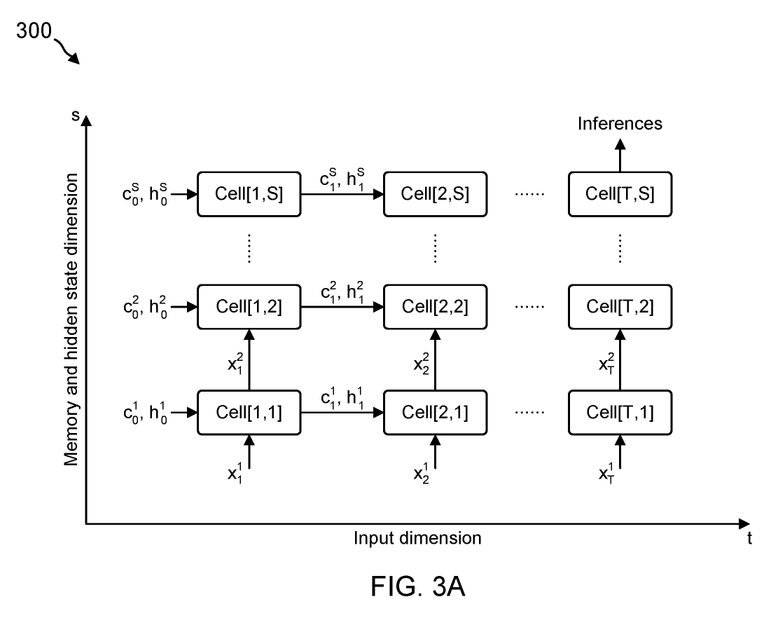

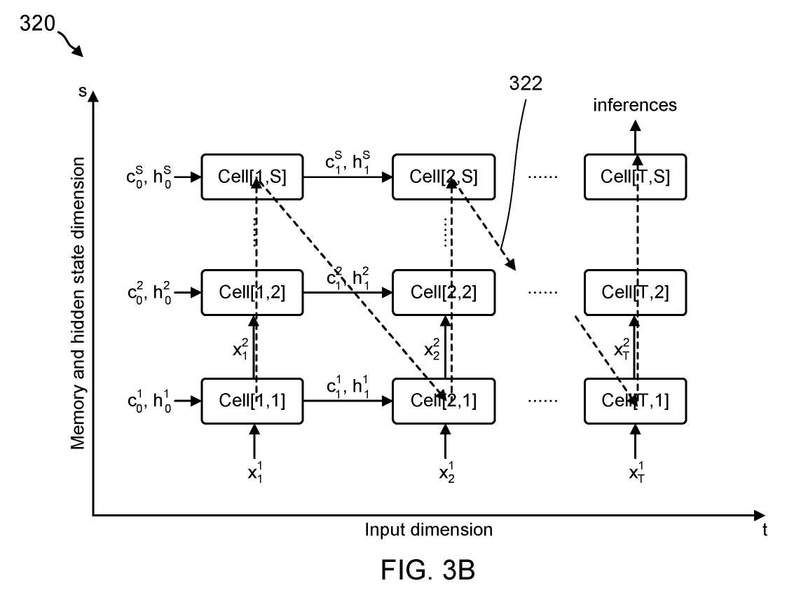

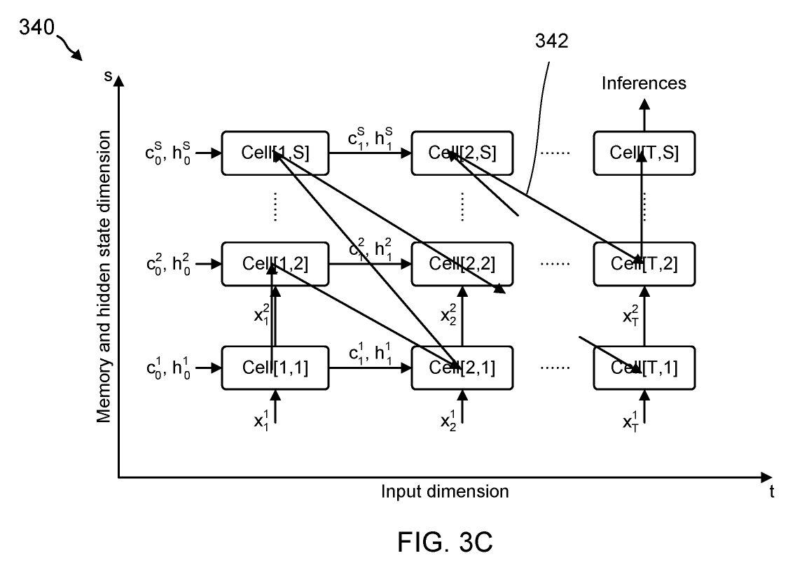

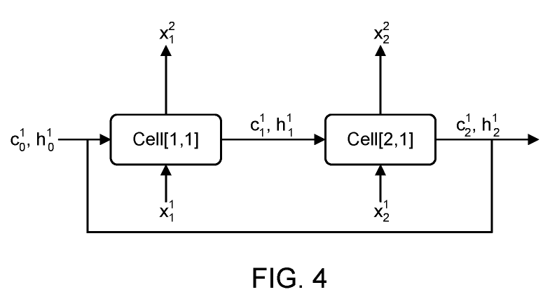

FIG. 3A is a block diagram illustrating an exemplary architecture of a recurrent neural network in the form of a long short-term memory (RNN/LSTM) in accordance with aspects of the present disclosure. A RNN is a class of architectures in which interconnected cells are configured to detect a pattern in a sequence of data. A LSTM is a type of RNN that enables learning of long term dependencies. Such a RNN/LSTM may perform the same task for each element of a sequence or other temporal data, with the output being dependent on the previous computations. Referring to FIG. 3A, a RNN/LSTM 300 may include a plurality of interconnected cells or nodes (cell[1,1]-cell[T,S]). Each cell may be configured to remember values over an arbitrary period of time t.

Referring to FIG. 3A, the cells (cell[1,1]-cell[T,S]) may be arranged in a grid or array, with each row comprising a layer in the RNN/LSTM 300. Each of the cells (cell[1,1]-cell[T,S]) may receive an input x_{T}^{S}. The input may, for instance, include data corresponding to an image, an audio signal (sample), a sequence, other temporal information or a portion thereof. In addition, each of the cells (e.g., cell[1,1]-cell[T,S]) may be configured to receive a memory state (e.g., c_{T-1}^{S}) and a hidden state (e.g., h_{T-1}^{S}) from a preceding cell of the same layer. The memory state may be the state of the cell, which is computed based on the previous state of the cell. On the other hand, the hidden state preserves the sequential information (e.g., the relationship of the inputs) of the RNN/LSTM as it is cascaded forward to subsequent cells and affects the processing of subsequent inputs over several time steps. In one example, cell[2,1] may receive the memory state c₁¹ and hidden state h₁¹ from cell[1,1].

Using an input and a prior memory state and hidden state, one or more processors (e.g., local processing unit 202) may execute each of the cells to computer an inference with respect to the input and operate the RNN/LSTM 300. Each of the cells (cell[1,1]-cell[T,S]) of RNN/LSTM 300 may be executed to compute an input (e.g., x_{T}^{S+1}) to a next cell in a next layer as well as a memory state c_{T}^{S}, and hidden state h_{T}^{S} for a subsequent cell of the same layer. For example, cell[2,1] may compute an input x₂² for cell[2,2], as well as a memory state c₂¹ and a hidden state h₂¹ for the next cell in the layer (e.g., cell [3,1], not shown). The input, memory state and hidden state may, for example, be computed according to the following equations:

$$\begin{matrix}{x}_{t}^{s + 1} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{o} ) & ( 1 ) \\ {c}_{t}^{s} = {f}_{t}^{s} * {c}_{t - 1}^{s} + {i}_{t}^{s} * {\tilde{c}}_{t}^{s} & ( 2 ) \\ {h}_{t}^{s} = {x}_{t}^{s + 1} * tanh ( {c}_{t}^{s} ) , \\ where & ( 3 ) \\ {f}_{t}^{s} = sigmoid ( [ \begin{matrix}{W}_{xf} \\ {W}_{xf}\end{matrix} ] \cdot [ \begin{matrix}{x}_{t}^{s} & {h}_{t - 1}^{s}\end{matrix} ] + {b}_{f} ) & ( 4 ) \\ {i}_{t}^{s} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{i} ) & ( 5 ) \\ {\tilde{c}}_{t}^{s} = tanh ( [ \begin{matrix}{W}_{xc} \\ {W}_{xc}\end{matrix} ] \cdot [ \begin{matrix}{x}_{t}^{s} & {h}_{t - 1}^{s}\end{matrix} ] + {b}_{c} ) & ( 6 )\end{matrix}$$

and where

$$W = [ [ \begin{matrix}{W}_{xf} \\ {W}_{xf}\end{matrix} ] [ \begin{matrix}{W}_{xi} \\ {W}_{xi}\end{matrix} ] [ \begin{matrix}{W}_{xc} \\ {W}_{xc}\end{matrix} ] [ \begin{matrix}{W}_{xi} \\ {W}_{xi}\end{matrix} ] ]$$

are weights of the RNN, b=[b_{f} bᵢb_{c} bₒ] are bias terms.

$$[ \begin{matrix}{W}_{xf} \\ {W}_{xf}\end{matrix} ]$$

ϵ [symbol] ^{(D+H)×H}, b_{f}ϵ [symbol] ^{H} may comprise forget parameters of an LSTM.

$$[ \begin{matrix}{W}_{xi} \\ {W}_{xi}\end{matrix} ]$$

ϵ [symbol] ^{(D+H)×H}, bᵢϵ [symbol] ^{H} may comprise input gate parameters,

$$[ \begin{matrix}{W}_{xc} \\ {W}_{xc}\end{matrix} ]$$

ϵ [symbol] ^{(D+H)×H}, b_{c}ϵ [symbol] ^{H} may comprise cell parameters,

$$[ \begin{matrix}{W}_{xo} \\ {W}_{xo}\end{matrix} ]$$

ϵ [symbol] ^{(D+H)×H}, bₒϵ [symbol] ^{H} are output gate parameters, and c₀¹ϵ [symbol] ^{H} is the initial memory state and h₀¹ϵ [symbol] ^{H} is the initial hidden state.

In accordance with aspects of the present disclosure, the execution of the cells of the RNN/LSTM 300 may be accelerated by partially overlapping the execution of cells of the model. The acceleration takes advantage of the dependencies of the cell outputs. In particular, the cell outputs may be produced at different times. That is, for each cell, a processor may compute and output the input to the next layer cell xₜ^{s+1} prior to computing the memory state cₜ^{s} and the hidden state hₜ^{s}. Additionally, the processor may output the memory state cₜ^{s} prior to computing the hidden state hₜ^{s}. Unlike, the memory state cₜ^{s} and the hidden state hₜ^{s}, the input xₜ^{s+1} is not dependent on the intermediate values fₜ^{s}, iₜ^{s}, and \tilde{c}ₜ^{s} of equations 4-6. Rather, as shown in equation 1, the input for the next layer cell xₜ^{s+1} is dependent on the current cell input xₜ^{s} and the prior cell hidden state hₜ₋₁^{s}. Because each of the values of the variables in equation 1 are known in advance of computing the current cell's hidden state hₜ^{s} and the current cell's memory state cₜ^{s}, a processor may compute the input for the next layer cell xₜ^{s+1} when the current cell inputs (e.g., xₜ^{s} and hₜ₋₁^{s}) are received. On the other hand, since, the current cell hidden state hₜ^{s} is dependent on the current cell memory state cₜ^{s}, the current cell memory state cₜ^{s} may be output and supplied to the next succeeding cell before the current cell hidden state hₜ^{s} may be output. As such, a processor executing the next layer cell may, upon receiving the input xₜ^{s+1}, begin executing the cell to produce the input (e.g., xₜ^{s+2}) for next succeeding layer cell (e.g., along the memory and hidden state dimension) if the prior hidden state for such cell is known. Likewise, a processor executing a next succeeding cell in the same layer (e.g., along the input dimension) may perform additional computations in advance of receiving the hidden state to further accelerate processing of the RNN/LTM 300.

In some aspects, one or more processors may compute the outputs of cells of the RNN/LSTM 300 according to the following exemplary pseudocode 1 defining an RNN/LSTM cell output:

$$[ \begin{matrix}{x}_{t}^{s + 1} & {c}_{t}^{s} & {h}_{t}^{s}\end{matrix} ] = LSTMcell ( t , s , W , b , {x}_{t}^{s} , {x}_{t - 1}^{s} , {c}_{t - 1}^{s} , {h}_{t - 1}^{s} ) \{ \\ {x}_{t}^{s + 1} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{o} ) \\ {f}_{t}^{s} = sigmoid ( [ \begin{matrix}{W}_{xf} \\ {W}_{xf}\end{matrix} ] \cdot [ \begin{matrix}{x}_{t}^{s} & {h}_{t - 1}^{s}\end{matrix} ] + {b}_{f} ) \\ {i}_{t}^{s} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{i} ) \\ {\tilde{c}}_{t}^{s} = tanh ( [ \begin{matrix}{W}_{xc} \\ {W}_{xc}\end{matrix} ] \cdot [ \begin{matrix}{x}_{t}^{s} & {h}_{t - 1}^{s}\end{matrix} ] + {b}_{c} ) \\ {c}_{t}^{s} = {f}_{t}^{s} * {c}_{t - 1}^{s} + {i}_{t}^{s} * {\tilde{c}}_{t}^{s} \\ {h}_{t}^{s} = {x}_{t}^{s + 1} * tanh ( {c}_{t}^{s} ) \\ \}$$

The exemplary pseudocode 1 may be arranged according to an order of independence. As such, a processor may execute the cell defined in the pseudocode to compute the input for the cell of the next layer xₜ^{s+1} prior to computing the intermediate values fₜ^{s}, iₜ^{s}, and \tilde{c}ₜ^{s}. The input xₜ^{s+1} may be supplied to the cell of the next layer. A processor may begin executing the cell of the next layer based on the received input xₜ^{s+1}. The execution for the next layer cell may be initiated. Rather than waiting for completion of the cell execution in producing the three noted outputs (e.g., xₜ^{s+1}, cₜ^{s}, hₜ^{s}), since xₜ^{s+1} depends on values that are known (e.g., sₜ^{s} and the prior hidden state hₜ₋₁^{s}), a processor may compute and output xₜ^{s+1} to a cell in the next succeeding layer, which may in turn, be executed in a similar manner. As such, the cell execution between a cell in a first layer (e.g., cell[1,1]) and execution of a cell in a subsequent layer (e.g., cell[1,2]) may be performed concurrently thereby overlapping execution on the memory and hidden state dimension s.

The RNN/LSTM 300 may be executed using a computing architecture configured to execute multiple cells in parallel. For example, the computing architecture may include multiple processors (e.g., local processing unit 202i, 202j of FIG. 2). In one example in which multiple processors are employed, a first processor may execute cell[1,1]. The cell[1,1] may receive the input x₁¹, initial memory state c₀¹ and initial hidden state h₀¹. In turn, the first processor (e.g., local processing unit 202i) (in accordance with the exemplary pseudocode 1 above) may compute input x₁², which may be output and supplied to cell[1,2]. The first processor may continue to execute cell [1,1] to compute the intermediate values f₁¹, i₁¹, and \tilde{c}₁¹, as well as the memory state c₁¹ and the hidden state h₁¹. A second processor (e.g., local processing unit 202j) may concurrently and, in some aspects, simultaneously, execute cell[1,2]. That is, when the input x₁² is received by cell[1,2], the second processor may begin to compute an input (e.g., x₁³) for a cell of a subsequent layer of the RNN/LSTM 300 (e.g., cell[1,3]) while the first processor continues to compute the intermediate values f₁¹, i₁¹, and i₁¹ and the memory state c₁¹ and the hidden state h₁¹.

In some aspects, a processor may execute the RNN/LSTM 300 using a straight model type execution or hyperplane type execution. FIG. 3B is a diagram illustrating the processing flow of an exemplary RNN/LSTM using a straight model execution approach. In the straight model execution, the cells of an RNN/LSTM 320 may be executed sequentially along the memory and hidden state dimension (e.g., in the vertical direction, column by column). In other words, the cells may executed sequentially for each time instance along execution path 322. For example, cell [1,1] receives the initial memory state c₀¹ and initial hidden state h₀¹ along with an input x₁¹ and in turn, a processor computes outputs x₁², c₁¹, h₁¹. The cell [1,1] supplies the computed input x₁² to cell [1,2] as an input. The cell[1,1] also supplies the memory state c₁¹ and the hidden state h₁¹ to the next cell in layer 1, cell [2,1]. The processor executes cell[1,2] based on the input x₁² along with the initial memory state c₀² and hidden state h₀² for layer 2 and computes outputs x₁³, c₁¹, and h₁¹. Processing continues along the cells in the column (e.g., time instance) and proceeds to the next succeeding column along the input dimension. For instance, cell[2,1] receives input x₂¹ along with the memory state c₁¹ and hidden state h₁¹ output by cell [1,1]. In turn, the processor executes cell[2,1] and computes outputs x₂², c_{T}¹, and h_{T}¹. The remaining cells in the RNN may be executed in similar manner until an inference is determined at each of the top layer cells (e.g., cell[1,S]-cell[T,S]).

In accordance with aspects of the present disclosure, multiple cells of the RNN/LSTM 320 may be processed concurrently. For example, a first processor may execute cell[1,S−1] (not shown) to compute an input x₁^{S} which may be supplied to cell[1,S]. The first processor may continue to execute cell[1,S−1] to compute the intermediate value and the memory state c₁^{S-1} and hidden state h₁^{S-1} outputs, while a second processor concurrently executes cell[1,S] to generate an inference regarding the input x₁¹.

In a second example, a first processor may execute cell[1,S] to compute the memory state cᵢ^{S} and hidden state h₁^{S} based on the input x₁^{S} and the initial memory state c₀^{S}, and initial hidden state hg. A second processor may concurrently execute cell[2,1] to generate the input x₂² based on the input x₂¹ as well as memory state c₁¹ and hidden state h₁¹ received from cell[1,1].

FIG. 3C, is a diagram illustrating the processing flow of an exemplary RNN/LSTM using a hyperplane execution approach. A hyperplane may correspond to a diagonal of the grid of cells. For instance, cell[1,2] and cell[2,1] may correspond to one hyperplane of the RNN/LSTM 340. Similarly, cell[1,S], cell[2,2] and cell[T,1] may correspond to another hyperplane.

In the hyperplane style of execution, the order of executing the cells may proceed according to the hyperplane. That is, the one or more processors may execute cells along a hyperplane and then may proceed to the next hyperplane to continue executing the RNN/LSTM 340 as indicated by execution path 342. For example, as shown in FIG. 3C, using the hyperplane order of execution, one or more processors may execute cell[1,1] and proceed to a next hyperplane. In the next hyperplane, one or more processors may execute cell[1,2] followed by cell[2,1]. The processing may then continue at a subsequent hyperplane at cell[1,S] and proceed along the subsequent hyperplane to cell[T,1]. The remaining cells in the RNN/LSTM 340 may be executed in similar manner until an inference is determined and output from cell[T,S].

In some aspects, a processor may execute the RNN/LSTM 340 using the hyperplane type execution. In one example, the RNN/LSTM 340 may be executed in accordance with the following exemplary pseudocode 2:

$$for t \text{:}$$

$$forall s \text{:} [ \begin{matrix}{x}_{t}^{s + 1} & {c}_{t}^{s} & {h}_{t}^{s}\end{matrix} ] = LSTMcell ( t , s , W , b , {x}_{t}^{s} , {x}_{t - 1}^{s} , {c}_{t - 1}^{s} , {h}_{t - 1}^{s} ) \{ \\ {x}_{t}^{s + 1} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{o} ) \\ {f}_{t}^{s} = sigmoid ( [ \begin{matrix}{W}_{xf} \\ {W}_{xf}\end{matrix} ] \cdot [ \begin{matrix}{x}_{t}^{s} & {h}_{t - 1}^{s}\end{matrix} ] + {b}_{f} ) \\ {i}_{t}^{s} = sigmoid ( [ \begin{matrix}{W}_{xi} \\ {W}_{xi}\end{matrix} ] \cdot [ \begin{matrix}{x}_{t}^{s} & {h}_{t - 1}^{s}\end{matrix} ] + {b}_{i} ) \\ {\tilde{c}}_{t}^{s} = tanh ( [ \begin{matrix}{W}_{xc} \\ {W}_{xc}\end{matrix} ] \cdot [ \begin{matrix}{x}_{t}^{s} & {h}_{t - 1}^{s}\end{matrix} ] + {b}_{c} ) \\ {c}_{t}^{s} = {f}_{t}^{s} * {c}_{t - 1}^{s} + {i}_{t}^{s} * {\tilde{c}}_{t}^{s} \\ {h}_{t}^{s} = {x}_{t}^{s + 1} * tanh ( {c}_{t}^{s} ) \\ \}$$

As shown in the exemplary pseudocode 2 for hyperplane execution, in the presence of an architecture for executing multiple cells in parallel, the iterations in the inner loop may be performed in parallel. That is, cells along a hyperplane may be executed in parallel. In some aspects, the number of processors utilized to process RNN/LSTM 340 may be set based on the number of cells along a diagonal. In some aspects, the processing may be scheduled optimally at the cell level. The overlapping of execution of the cells along hyperplanes may effectively squeezing the hyperplanes together or compacting the model such that the time to compute an inference may be reduced.

In accordance with aspects of the present disclosure, multiple cells of the RNN/LSTM 340 may be processed concurrently. For example, a first processor may execute cell[1,1] to compute an input x₁² which may be supplied to cell[1,2]. The first processor may continue to execute cell[1,1] to compute the intermediate values f₁¹, i₁¹, and \tilde{c}₁¹ as well as the memory state c₁¹ and hidden state h₁¹ outputs according to equations 2 and 3 respectively, while a second processor concurrently executes cell[1,2] to compute input x₁³ based on the received input x₁² and the initial hidden state h₀².

In a second example, a first processor may execute cell[1,2] to compute the memory state c₁² and hidden state h₁² based on the input x₁² and the initial memory state c₀² and initial hidden state h₀². A second processor may concurrently execute cell[2,1] to compute input x₂² based on the input x₂¹ and the hidden state h₁¹ received from cell[1,1].

In a third example, a first processor may execute cell[1,S] to compute the memory state c₁^{S} and hidden state h₁^{S} based on the input x₁^{S} and the initial memory state c₀^{S} and initial hidden state h₀^{S}. A second processor may concurrently execute cell[2,2] to compute one or more of an input x₂³, memory state c₂² and the hidden state h₂². Additionally, a third processor may execute cell[T,1] in parallel with the execution of cell[1,S] and cell[2,2] to compute input x_{T}².

In some aspects, the processing of the cells of an RNN/LSTM (e.g., RNN/LSTM 300) may be further accelerated by simultaneously computing the intermediate values fₜ^{s}, iₜ^{s}, and \tilde{c}ₜ^{s}.

In operation, the RNN/LSTM (e.g., RNN/LSTM 340) may be used to determine an inference with respect to a given input. In one example, the input may be a sequence of audio data and the RNN/LSTM may be trained for speech recognition. The audio data may be divided into portions or chunks and supplied to the RNN/LSTM 340 as x=[x₁¹ . . . x₁^{T}]. For instance, each portion may correspond to a word within the sequence of audio data. Cell[1,1] may receive input x₁¹ along with the initial memory state c₀¹ and initial hidden state h₀¹. In some aspects, the initial hidden state and the initial memory state may be initialized to a predefined value (e.g., 0), a random value or other initial value. A first processor may execute cell[1,1] to compute the input x₁². For example, the first processor may concatenate the received input x₁¹ and the initial hidden state h₀¹, the result of which may be scaled via matrix multiplication based on the input gate parameters

$$[ \begin{matrix}{W}_{xi} \\ {W}_{xi}\end{matrix} ]$$

[symbol]

^{(D+H)×H}. A bias term bₒ may be added to the scaled result. The bias term may be a scalar value added to ensure that at least some cells are activated (e.g., produce a value other than zero). The first processor may then compute the sigmoid function of the sum of the scaled result and the bias term thereby squashing the sum to a value between 1 and −1. The squashed sum may be output as x₁² and may be supplied to cell [1,2] as input. In some aspects, the output x₁² may serve as a first estimate or prediction of a label or inference for the input x₁¹. Each successive layer of the RNN/LSTM may recognize an increasing level of features, thereby refining the prediction until the final layer in which the prediction of a label or inference is output. The first processor may then proceed to sequentially compute intermediate value f₁¹, i₁¹, and \tilde{c}₁¹ followed by the memory state c₁¹ and the hidden state h₁¹ in accordance with pseudocode 2. A second processor, operating in parallel with the first processor, may concurrently execute cell[1,2] to compute input x₁³, memory state c₁² and the hidden state h₁². When the first processor outputs the memory state c₁¹ and the hidden state h₁¹ to cell[2,1], the first processor (or another processor) may execute cell[2,1] to predict a label or inference (e.g., a word) for the second portion of the input sequence (e.g., input x₂¹). In some aspects, processing at cell[2,1] may be initiated in advance of receiving the outputs from cell[1,1] (e.g., the memory state and/or hidden state). For example, a processor may begin executing cell[2,1] by computing partial values used in computing cell outputs of cell[2,1]. In one example, a processor may compute the matrix multiplication of the input gate parameters (e.g.,

$$[ \begin{matrix}{W}_{xi} \\ {W}_{xi}\end{matrix} ] )$$

and the current input, input x₂¹. Computing such partial values using the known values (e.g., the current input and cell parameters) in advance of receiving the outputs from the prior cell (e.g., the memory state and/or hidden state) may further accelerate execution of an RNN/LSTM (e.g., RNN/LSTM 320 and RNN/LSTM 340) and reduce the time for computing an inference. When the hidden state and/or memory state are received, the processor may execute the cell to compute the remaining partial values.

The first processor may be operated in parallel with the second processor and may concurrently compute an output x₂² based on the second portion of the input sequence, input x₂¹ and the received hidden state h₁¹ from cell[1,1]. In this way, the hidden state h₁¹ propagates the prediction of the prior cell (e.g., cell[1,1]) which may be used to influence the prediction the current cell (e.g., cell[2,1]). As such, correlations between inputs separated by time may be recognized and used to improve the inference or label determination. For example, a hidden state h₁¹ indicating that the first portion of the input x₁¹ likely corresponds to “duck” may influence a prediction from cell[2,1] that the second portion of the input x₂¹ is more likely to be “quack” than “quick”.

The processing of the RNN/LSTM 340 cell may continue according to the hyperplane style of execution (e.g., along execution path 342). Multiple processors may be employed to concurrently execute the cells along each a hyperplane wave front (e.g., diagonal of the RNN/LSTM cells) with the cells of each subsequent layer being executed to recognized further features and refine the predicted inference relative to each input until an inference is generated at the outputs of the top layer cells (e.g., cell[1,S], cell[2,S], . . . , cell[T,S]).

FIG. 4 is a block diagram illustrating a bidirectional cells of an RNN/LSTM in accordance with aspects of the present disclosure. Each cell of an RNN/LSTM (e.g., RNN/LSTM 300) may be configured as a bidirectional cell. That is, each cell may be configured with a feedback path to a preceding cell. Referring to FIG. 4, cell[2,1] is configured with a feedback path 402 to cell[1,1]. A processor executing cell[2,1] may compute the memory state c₂¹ and the hidden state h₂¹. In addition to supplying the next succeeding cell in the layer, the processor may supply the memory state c₂¹ and the hidden state h₂¹ to cell[1,1] via the feedback path 402. In turn, a processor may re-execute cell[1,1] to re-compute the output x₁² along with the memory state c₁¹ and the hidden state h₁¹. In doing so, the initial predicted inference with respect to input x₁¹ may be influenced based on information from the subsequent cell (e.g., cell[2,1]). Following the previous example, a hidden state h₂¹ indicating that the second portion of the input sequence (e.g. x₂¹) likely corresponds to “quack” may influence a prediction from cell[1,1] that the first portion of the input sequence (e.g., x₁¹) is more likely to be “ducks” than to “duck” (e.g., using grammar rules related to subject-verb agreement).

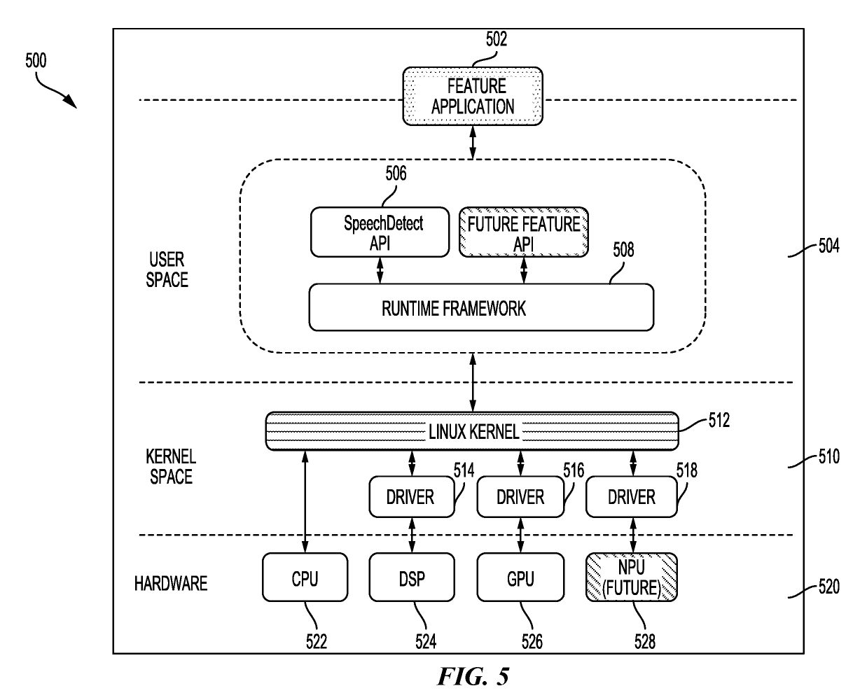

FIG. 5 is a block diagram illustrating an exemplary software architecture 500 that may modularize artificial intelligence (AI) functions. Using the architecture, application 502 may be designed to cause various processing blocks of an SOC 520 (for example a CPU 522, a DSP 524, a GPU 526 and/or an NPU 528) to perform supporting computations during run-time operation of the application 502.

The AI application 502 may be configured to call functions defined in a user space 504 that may, for example, provide for the detection and recognition of a scene indicative of sequence data such as audio data of sounds observed or characters in an image observed via the device. The AI application 502 may, for example, configure a microphone and a camera differently depending on whether the speech to be recognized is an office, a lecture hall, a restaurant, or an outdoor setting with wind noise. The AI application 502 may make a request to compiled program code associated with a library defined in a SpeechDetect application programming interface (API) 506 to provide an estimate of the current speech. This request may ultimately rely on the output of a deep neural network configured to provide inferences of the speech content based on audio and temporal sequence data, for example.

A run-time engine 508, which may be compiled code of a Runtime Framework, may be further accessible to the AI application 502. The AI application 502 may cause the run-time engine, for example, to request a speech estimate at a particular time interval or be triggered by an event detected by the user interface of the application. When caused to estimate the speech, the run-time engine may in turn send a signal to an operating system 510, such as a Linux Kernel 512, running on the SOC 520. The operating system 510, in turn, may cause a computation to be performed on the CPU 522, the DSP 524, the GPU 526, the NPU 528, or some combination thereof. The CPU 522 may be accessed directly by the operating system, and other processing blocks may be accessed through a driver, such as a driver 514-518 for a DSP 524, for a GPU 526, or for an NPU 528. In the exemplary example, the deep neural network such as RNN/LSTM 300 may be configured to run on a combination of processing blocks, such as a CPU 522 and a GPU 526, or may be run on an NPU 528, if present.

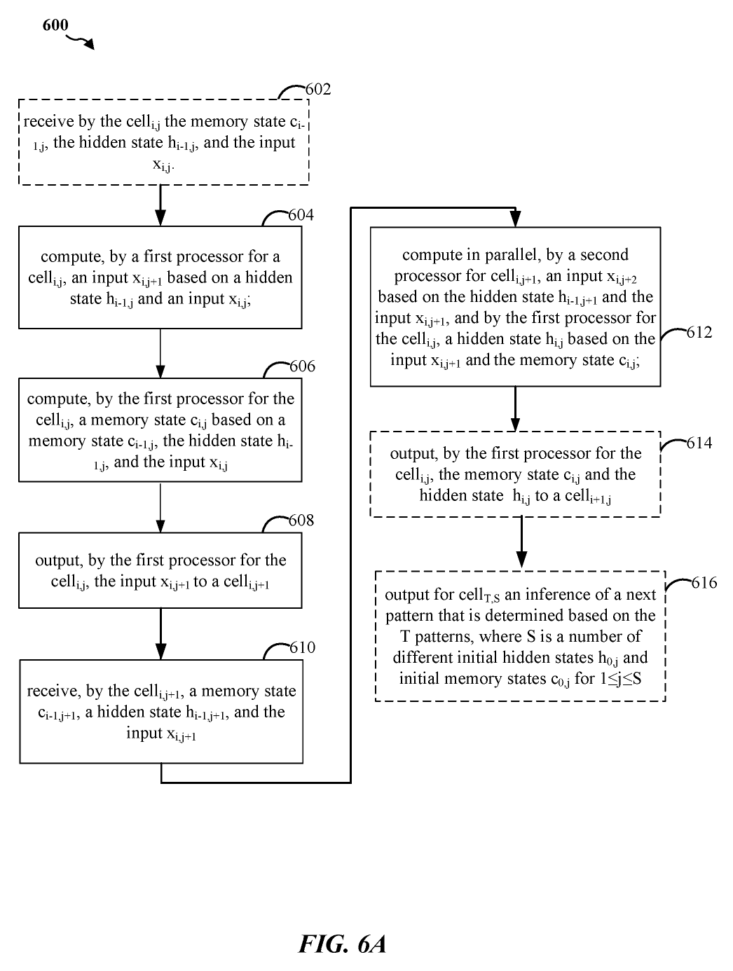

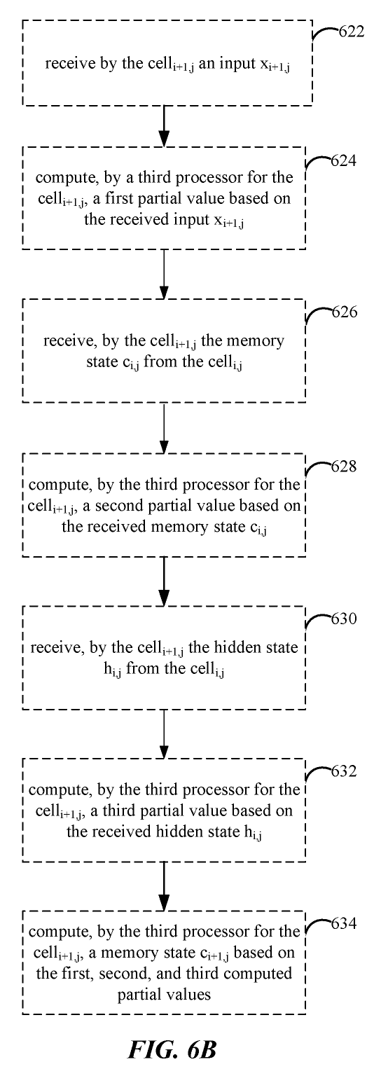

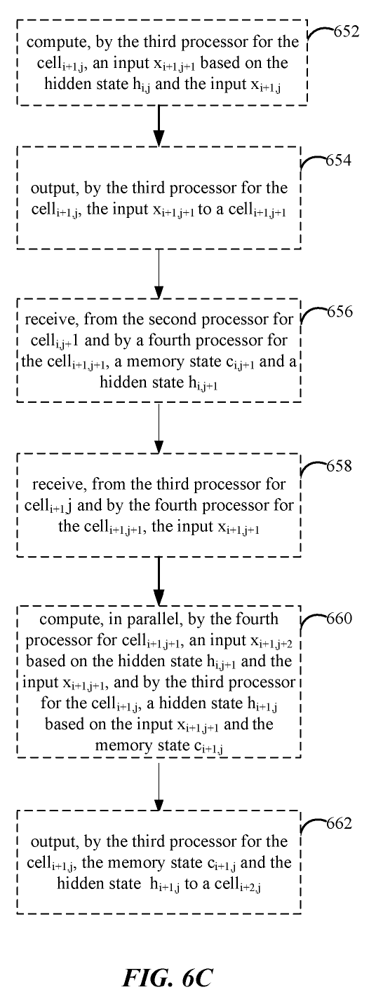

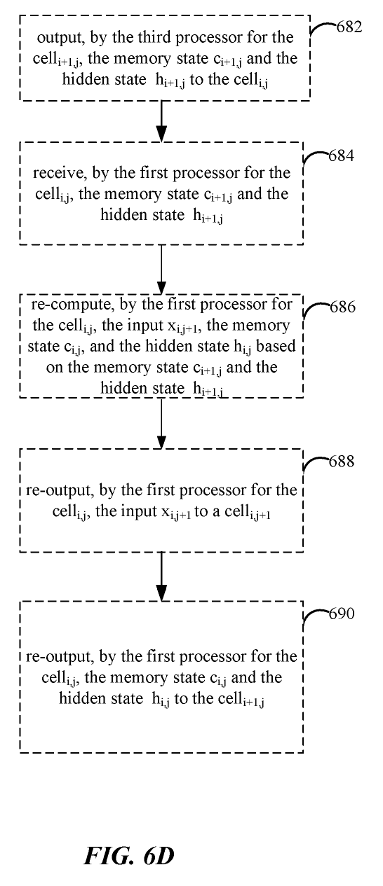

FIG. 6A-D illustrates an exemplary method 600 for operating a computational network. The method may be implemented using one or more processors (e.g., local processing units 200), for example. Referring to FIG. 6A, in block 602, a cell_{i,j} may optionally receive a memory state c_{i-1,j}, a hidden state h_{i-1,j}, and an input x_{i,j}. For example, as shown in FIG. 3A, cell[2,1] receives an input such as sequence data. The sequence data may include audio data, video data or other temporal data, for example. The sequence data may be retrieved from a memory, such as memory 118 for instance. In some aspects, the sequence data may be streamed from a sensor via sensors 114 or via a multimedia source such as a camera or microphone via multimedia 112. In addition, cell[2,1] may receive a memory state and a hidden state for the preceding cell of the RNN/LSTM 300 (cell[1,1]).

In block 604, a first processor may compute for the cell_{i,j}, an input x_{i,j+1} based on the hidden state h_{i-1,j} and the input x_{i,j}. Referring to FIG. 3C, each cell of RNN/LSTM 340 may compute an input for a next layer cell according to equation 1, for example. As indicated above with respect to FIG. 3C, the first processor may execute cell[1,1] to compute an input x₁² which may be supplied to cell[1,2], for instance.

In block 606, the first processor may compute for the cell_{i,j}, a memory state c_{i,j} based on a memory state c_{i-1,j}, the hidden state h_{i-1,j}, and the input x_{i,j}. As described above with respect to FIG. 3C, the first processor may continue to execute cell[1,1] to compute the memory state c₁¹ and hidden state h₁¹ outputs according to equations 2 and 3, respectively.

In block 608, the first processor may output for the cell_{i,j}, the input x_{i,j+1} to a cell_{i,j+1}. For example, as shown in FIG. 3C, the cell[1,1] output x₁² is supplied to cell[1,2].

In block 610, the cell_{i,j+1} may receive a memory state a hidden state h_{i-1,j+1}, and the input x_{i,j+1}. For example, as shown in FIG. 3C, the cell[1,2] receives the prior memory state and hidden state values (e.g., initial memory state c₀² and initial hidden state h₀²) as inputs along with input x₁² from the cell[1,1].

In block 612, a second processor may compute, for cell_{i,j+1}, an input x_{i,j+2} based on the hidden state h_{i-1,j+1} and the input x_{i,j+1}, in parallel with computing by the first processor for the cell_{i,j}, a hidden state h_{i,j} based on the input x_{i,j+1} and the memory state c_{i,j}. For example, as shown in FIG. 3C, the first processor may continue to execute cell[1,1] to compute the intermediate values f₁¹, i₁¹, and \tilde{c}₁¹ as well as the memory state c₁¹ and hidden state h₁¹ outputs according to equations 2 and 3 respectively, while a second processor concurrently executes cell[1,2] to compute input x₁³ based on the received input x₁² and the initial hidden state h₀².

In block 614, the first processor may output for the cell_{i,j}, the memory state c_{i,j} and the hidden state h_{i,j} to a cell_{i+1,j}. For example, as shown in FIG. 3C, cell[1,1] outputs the memory state c₁¹ and hidden state h₁¹ to cell[2,1].

In block 616, a cell_{T,S} may output an inference of a next pattern that is determined based on the T patterns, where S is a number of different initial hidden states h_{0,j} and initial memory states c_{0,j} for 1≤j≤S. For instance, as described above with reference to FIG. 3C, the output x₁² may serve as a first estimate or prediction of a label or inference for the input x₁¹. Each successive layer of the RNN/LSTM may recognize an increasing level of features, thereby refining the prediction until the final layer in which the prediction of a label or inference is output.

Referring to FIG. 6B, in block 622, cell_{i+1,j} may receive an input x_{i+1,j}. For example, as shown in FIG. 3C, cell[2,1] may receive an input x₂¹. In block 624, a third processor may for the cell_{i+1,j}, a first partial value based on the received input x_{i+1,j}. In block 626, the cell_{i+1,j} may receive the memory state c_{i,j} from the cell_{i,j}. In block 628, the third processor may compute for the cell_{i+1,j}, a second partial value based on the received memory state c_{i,j}. In block 630, the cell_{i+1,j} may receive the hidden state h_{i,j} from the cell_{i,j}. In block 632, the third processor may computing for the cell_{i+1,j}, a third partial value based on the received hidden state h_{i,j}. In block 634, the third processor may also compute for the cell_{i+1,j}, a memory state c_{i+1,j} based on the first, second, and third partial values. In one example, as discussed above with respect to FIG. 3C, processing at cell[2,1] may be initiated in advance of receiving the outputs from cell[1,1] (e.g., the memory state and/or hidden state). For instance, a processor may begin executing cell[2,1] by computing partial values used in computing cell outputs of cell[2,1]. In one example, a processor may compute the matrix multiplication of the input gate parameters

$$[ \begin{matrix}{W}_{xi} \\ {W}_{xi}\end{matrix} ]$$

and the current input, input x₂¹. When the memory state c₁¹ and the hidden state h₁¹ are received from cell [1,1], the processor may compute the remaining partial values in order to compute the input x₂², as well as the memory state c₂¹ and hidden state h₂¹. By computing such partial values using the known values in advance of receiving the outputs from a prior cell, the processor(s) may accelerate execution of an RNN/LSTM (e.g., RNN/LSTM 320 and RNN/LSTM 340) and reduce the time for computing an inference. This in effect may result in compaction of the model in the input dimension t.

Referring to FIG. 6C, in block 652, the third processor may compute for the cell_{i+1,j}, an input x_{i+1,j+1} based on the hidden state h_{i,j} and the input x_{i+1,j}. In block 654, the third processor may output for the cell_{i+1,j}, the input x_{i+1,j+1} to a cell_{i+1,j+1}. In block 656, the second processor may receive for cell_{i,j+}1 and by a fourth processor for the cell_{i+1,j+1}, a memory state c_{i,j+1} and a hidden state h_{i,j+1}. In block 658, the third processor may receive for cell_{i+1,j} and by the fourth processor for the cell_{i+1,j+i}, the input x_{i+1,j+1}. In block 660, the fourth processor may compute, in parallel, for cell_{i+1,j+1}, an input x_{i+1,j+2} based on the hidden state h_{i,j+1} and the input x_{i+1,j+1}, and the third processor may compute for the cell_{i+1,j}, a hidden state h_{i+1,j} based on the input x_{i+1,j+1} and the memory state c_{i+1,j}. In block 662, the third processor may output for the cell_{i+1,j}, the memory state c_{i+1,j} and the hidden state h_{i+1,j} to a cell_{i+2,j}. For example, as disclosed above with respect to FIG. 3C, multiple processor may concurrently execute cells along a hyperplane or a diagonal of the grid of cells. In one example, a first processor may execute cell[1,S] to compute the memory state cᵢ^{S} and hidden state h₁^{S} based on the input x₁^{S} and the initial memory state c₀^{S}, and initial hidden state h₀^{S}. A second processor may concurrently execute cell[2,2] to compute one or more of an input x₂³, memory state c₂² and the hidden state h₂². Additionally, a third processor may execute cell[T,1] in parallel with the execution of cell[1,S] and cell[2,2] to compute input x_{T}².

Referring to FIG. 6D, in block 682, the third processor may output for the cell_{i+1,j}, the memory state c_{i+1,j} and the hidden state h_{i+1,j} to the cell_{i,j}. In block 684, the first processor may receive for the cell_{i,j}, the memory state c_{i+1,j} and the hidden state h_{i+1,j}. In block 686, the first processor may re-compute for the cell_{i,j}, the input x_{i,j+1}, the memory state c_{i,j}, and the hidden state h_{i,j} based on the memory state c_{i+1,j} and the hidden state h_{i+1,j}. In block 688, the first processor may re-output for the cell_{i,j}, the input x_{i,j+1} to a cell_{i,j+1}. In block 690, the first processor may re-output for the cell_{i,j}, the memory state c_{i,j} and the hidden state h_{i,j} to the cell_{i+1,j}. For example, as discussed above with respect to FIG. 4, each cell of an RNN/LSTM (e.g., RNN/LSTM 300) may be configured as a bidirectional cell. Each cell may be configured with a feedback path to a preceding cell. Referring to FIG. 4, cell[2,1] is configured with a feedback path 402 to cell[1,1]. A processor executing cell[2,1] may compute the memory state c₂¹ and the hidden state h₂¹. In addition to supplying the next succeeding cell in the layer, the processor may supply the memory state c₂¹ and the hidden state h₂¹ to cell[1,1] via the feedback path 402. In turn, a processor may re-execute cell[1,1] to re-compute the output x₁² along with the memory state c₁¹ and the hidden state h₁¹. In doing so, the initial predicted inference with respect to input x₁¹ may be influenced based on information from the subsequent cell (e.g., cell[2,1]). Following the previous example, a hidden state h₂¹ indicating that the second portion of the input sequence (e.g. x₂¹) likely corresponds to “quack” may influence a prediction from cell[1,1] that the first portion of the input sequence (e.g., x₁¹) is more likely to be “ducks” than to “duck” (e.g., using grammar rules related to subject-verb agreement).

In one configuration, an apparatus is configured for operating a computational network and include means for computing, for a cell_{i,j}, an input x_{i,j+1} based on a hidden state h_{i-1,j} and an input x_{i,j} and means for computing, for the cell_{i,j}, a memory state c_{i,j} based on a memory state c_{i-1,j}, the hidden state h_{i-1,j}, and the input x_{i,j}. The apparatus also includes means for receiving, by the cell_{i,j+1}, a memory state c_{i-1,j+1}, a hidden state h_{i-1,j+1}, and the input x_{i,j+1}. The apparatus further includes means for computing in parallel, for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}. In one aspect, the aforementioned means may be the general-purpose processor 102, program memory associated with the general-purpose processor 102, memory block 118, local processing units 202, and or the routing connection processing units 216 configured to perform the functions recited. In another configuration, the aforementioned means may be any component or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

In some aspects, method 600 may be performed by the SOC 100 (FIG. 1) or the system 200 (FIG. 2). That is, each of the elements of methods 600 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, components and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software component executed by a processor, or in a combination of the two. A software component may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software component may include a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may include a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may include packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may include one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may include a number of software components. The software components include instructions that, when executed by the processor, cause the processing system to perform various functions. The software components may include a transmission component and a receiving component. Each software component may reside in a single storage device or be distributed across multiple storage devices. By way of example, a software component may be loaded into RAM from a hard drive when a triggering event occurs. During execution of the software component, the processor may load some of the instructions into cache to increase access speed. One or more cache lines may then be loaded into a general register file for execution by the processor. When referring to the functionality of a software component below, it will be understood that such functionality is implemented by the processor when executing instructions from that software component. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer-readable media (e.g., a signal). Combinations of the above should also be included within the scope of computer-readable media.

Thus, certain aspects may include a computer program product for performing the operations presented herein. For example, such a computer program product may include a computer-readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of operating a computational network, comprising:
computing, by a first processor for a cell_{i,j}, an input x_{i,j+1} based on a hidden state h_{i-1,j} and an input x_{i,j};
computing, by the first processor for the cell_{i,j}, a memory state c_{i,j} based on a memory state c_{i-1,j}, the hidden state h_{i-1,j}, and the input x_{i,j};
outputting, by the first processor for the cell_{i,j}, the input x_{i,j+1} to a cell_{i,j+1};
receiving, by the cell_{i,j+1}, a memory state c_{i-1,j+1}, a hidden state h_{i-1,j+1} and the input x_{i,j+1}; and
computing in parallel, by a second processor for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}.

2. The method of claim 1, further comprising:
outputting, by the first processor for the cell_{i,j}, the memory state c_{i,j} and the hidden state h_{i,j} to a cell_{i+1,j}; and
receiving by the cell_{i,j} the memory state the hidden state h_{i-1,j} and the input x_{i,j}.

3. The method of claim 2, wherein the memory state c_{i-1,j} and the hidden state h_{i-1,j} are received by the cell_{i,j} from a cell_{i-1,j} and the input x_{i,j} is received by the cell_{i,j} from a cell_{i,j-1}.

4. The method of claim 1, wherein the first processor computes the memory state c_{i,j} based on a first variable that is a function of the hidden state h_{i-1,j} and the input x_{i,j}, a second variable that is a function of the hidden state h_{i-1,j} and the input x_{i,j}, and a third variable that is a function of the hidden state h_{i-1,j} and the input x_{i,j}, wherein at least two of the first, second and third variables are computed in parallel.

5. The method of claim 1, wherein each input x_{i,1} for 1≤i≤T is a pattern, and the method further comprises outputting for cell_{T,S} an inference of a next pattern that is determined based on the T patterns, where S is a number of different initial hidden states h_{0,j} and initial memory states c_{0,j} for 1≤j≤S.

6. The method of claim 1, further comprising outputting, by the first processor for the cell_{i,j}, the memory state c_{i,j} to a cell_{i+1,j} before the computing by the first processor for the cell_{i,j}, the hidden state h_{i,j}.

7. The method of claim 6, further comprising:
receiving by the cell_{i+1,j} an input x_{i+1,j};
computing, by a third processor for the cell_{i+1,j} a first partial value based on the received input x_{i+1,j};
receiving by the cell_{i+1,j} the memory state c_{i,j} from the cell_{i,j};
computing, by the third processor for the cell_{i+1,j}, a second partial value based on the received memory state c_{i,j};
receiving by the cell_{i+1,j} the hidden state h_{i,j} from the cell_{i,j};
computing, by the third processor for the cell_{i+1,j}, a third partial value based on the received hidden state h_{i,j}; and
computing, by the third processor for the cell_{i+1,j}, a memory state c_{i+1,j} based on the first partial value, the second partial value, and the third partial value.

8. The method of claim 7, further comprising:
computing, by the third processor for the cell_{i+1,j},an input x_{i+1,j+1} based on the hidden state h_{i,j} and the input x_{i+1,j};
outputting, by the third processor for the cell_{i+1,j}, the input x_{i+1,j+1} to a cell_{i+1,j+1};
receiving, from the second processor for cell_{i,j+1} and by a fourth processor for the cell_{i+1,j+1}, a memory state c_{i,j+1} and a hidden state h_{i,j+1};
receiving, from the third processor for the cell_{i+1,j} and by the fourth processor for the cell_{i+1,j+1}, the input x_{i+1,j+1};
computing in parallel, by the fourth processor for cell_{i+1,j+1}, an input x_{i+1,j+2} based on the hidden state h_{i,j+1} and the input x_{1+1,j+1}, and by the third processor for the cell_{i+1,j}, a hidden state h_{i+1,j} based on the input x_{i+1,j+1} and the memory state c_{i+1,j}; and
outputting, by the third processor for the cell_{i+1,j}, the memory state c_{i+1,j} and the hidden state h_{i+1,j} to a cell_{i+2,j}.

9. The method of claim 8, further comprising:
outputting, by the third processor for the cell_{i+1,j}, the memory state c_{i+1,j} and the hidden state h_{i+1,j} to the cell_{i,j};
receiving, by the first processor for the cell_{i,j}, the memory state c_{i+1,j} and the hidden state h_{i+1,j};
re-computing, by the first processor for the cell_{i,j}, the input x_{i,j+1}, the memory state c_{i,j}, and the hidden state h_{i,j} based on the memory state c_{i+1,j} and the hidden state h_{i+1,j};
re-outputting, by the first processor for the cell_{i,j}, the input x_{i,j+1} to a cell_{i,j+1}; and
re-outputting, by the first processor for the cell_{i,j}, the memory state c_{i,j} and the hidden state h_{i,j} to the cell_{i+1,j}.

10. An apparatus of operating a computational network, comprising:
a memory; and
at least one processor coupled to the memory, the at least one processor being configured to:
compute, for a cell_{i,j}, an input x_{i,j+1} based on a hidden state h_{i-1,j} and an input x_{i,j};
compute, for the cell_{i,j}, a memory state c_{i,j} based on a memory state c_{i-1,j}, the hidden state h_{i-1,j}, and the input x_{i,j};
output, for the cell_{i,j}, the input x_{i,j+1} to a cell_{i,j+1};
receive, by the cell_{i,j+1}, a memory state c_{i-1,j+1}, a hidden state h_{i-1,j+1}, and the input x_{i,j+1}; and
compute in parallel, for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}.

11. The apparatus of claim 10, wherein the at least one processor is further configured to:
output, for the cell_{i,j}, the memory state c_{i,j} and the hidden state h_{i,j} to a cell_{i+1,j}; and
receive by the cell_{i,j} the memory state the hidden state h_{i-1,j}, and the input x_{i,j}.

12. The apparatus of claim 11, wherein the at least one processor is further configured to receive by the cell_{i,j} from a cell_{i-1,j} memory state c_{i-1,j} and the hidden state h_{i-1,j}, and configured to receive by the cell_{i,j} from a cell_{i,j-1}, the input x_{i,j}.

13. The apparatus of claim 10, wherein the at least one processor is further configured to compute the memory state c_{i,j} based on a first variable that is a function of the hidden state h_{i-1,j} and the input x_{i,j}, a second variable that is a function of the hidden state h_{i-1,j} and the input x_{i,j}, and a third variable that is a function of the hidden state h_{i-1,j} and the input x_{i,j}, wherein at least two of the first, second and third variables are computed in parallel.

14. The apparatus of claim 10, wherein each input x_{i,1} for 1≤i≤T is a pattern, and wherein the at least one processor is further configured to output for cell_{T,S} an inference of a next pattern that is determined based on the T patterns, where S is a number of different initial hidden states h_{0,j} and initial memory states c_{0,j} for 1≤j≤S.

15. The apparatus of claim 10, wherein the at least one processor is further configured to output, for the cell_{i,j}, the memory state c_{i,j} to a cell_{i+1,j} before the computing for the cell_{i,j}, the hidden state h_{i,j}.

16. The apparatus of claim 15, wherein the at least one processor is further configured to:
receive by the Cell_{i+1,j} an input x_{i+1,j};
compute, for the cell_{i+1,j}, a first partial value based on the received input x_{i+1,j};
receive by the cell_{i+1,j} the memory state c_{i,j} from the cell_{i,j};
compute, for the cell_{i+1,j}, a second partial value based on the received memory state c_{i,j};
receive by the cell_{i+1,j} the hidden state h_{i,j} from the cell_{i,j};
compute, for the cell_{i+1,j}, a third partial value based on the received hidden state h_{i,j}; and
compute, for the cell_{i+1,j}, a memory state c_{1+1,j} based on the first partial value, the second partial value, and the third partial value.

17. The apparatus of claim 16, wherein the at least one processor is further configured to:
compute, for the cell_{i+1,j}, an input x_{i+1,j+1} based on the hidden state h_{i,j} and the input x_{i+1,j};
output, for the cell_{i+1,j}, the input x_{i+1,j+1} to a cell_{i+1,j+1};
receive, for cell_{i,j+1} and for the cell_{i+1,j+1}, a memory state c_{i,j+1} and a hidden state h_{i,j+1};
receive, for cell_{i+1,j} and for the cell_{i+1,j+1}, the input x_{i+1,j+1}; and
compute in parallel, for cell_{i+1,j+1}, an input x_{i+1,j+2} based on the hidden state h_{i,j+1} and the input x_{i+1,j+1}, and for the cell_{i+1,j}, a hidden state h_{i+1,j} based on the input x_{i+1,j+1} and the memory state c_{i+1,j}; and
output, for the cell_{i+1,j}, the memory state c_{i+1,j} and the hidden state h_{i+1,j} to a cell_{i+2,j}.

18. The apparatus of claim 17, wherein the at least one processor is further configured to:
output, for the cell_{i+1,j}, the memory state c_{i+1,j} and the hidden state h_{i+1,j} to the cell_{i,j};
receive, for the cell_{i,j}, the memory state c_{i+1,j} and the hidden state h_{i+1,j};
re-compute, for the cell_{i,j}, the input x_{i,j+1}, the memory state c_{i,j}, and the hidden state h_{i,j} based on the memory state c_{i+1,j} and the hidden state h_{i+1,j};
re-output, for the cell_{i,j}, the input x_{i,j+1} to a cell_{i,j+1}; and
re-output, for the cell_{i,j}, the memory state c_{i,j} and the hidden state h_{i,j} to the cell_{i+1,j}.

19. An apparatus for operating a computational network, comprising:
means for computing, by a first processor for a cell_{i,j}, an input x_{i,j+1} based on a hidden state h_{i-1,j} and an input x_{i,j};
means for computing, by the first processor for the cell_{i,j}, a memory state c_{i,j} based on a memory state c_{i-1,j}, the hidden state h_{i-1,j}, and the input x_{i,j};
means for outputting, by the first processor for the cell_{i,j}, the input x_{i,j+1} to a cell_{i,j+1};
means for receiving, by the cell_{i,j+1}, a memory state c_{i-1,j+1,} a hidden state and the input x_{i,j+1};
means for computing in parallel, by a second processor for cell_{i,j+1}, an input x_{i,j+2} based on the hidden state h_{i-1,j+1} and the input x_{i,j+1}, and by the first processor for the cell_{i,j}, a hidden state h_{i,j} based on the input x_{i,j+1} and the memory state c_{i,j}; and
means for outputting, by the first processor for the cell_{i,j}, the memory state c_{i,j} and the hidden state h_{i,j} to a cell_{i+1,j}.

20. The apparatus of claim 19, further comprising means for computing the memory state c_{i,j} based on a first variable that is a function of the hidden state h_{i-1,j} and the input x_{i,j}, a second variable that is a function of the hidden state h_{i-1,j} and the input x_{i j}, and a third variable that is a function of the hidden state h_{i-1,j} and the input x_{i,j}, wherein at least two of the first, second and third variables are computed in parallel.

21. The apparatus of claim 19, wherein each input x_{i,1} for 1≤i≤T is a pattern, and further comprising means for outputting for cell_{T,S} an inference of a next pattern that is determined based on the T patterns, where S is a number of different initial hidden states h_{0,j} and initial memory states c_{0,j} for 1≤j≤S.

22. The apparatus of claim 19, further comprising means for outputting, for the cell_{i,j}, the memory state c_{i,j} to the cell_{i+1,j} before the computing for the cell_{i,j}, the hidden state h_{i,j}.

23. The apparatus of claim 22, further comprising:
means for receiving by the cell_{i+1,j} an input x_{i+1,j};
means for computing, for the cell_{i+1,j}, a first partial value based on the received input x_{i+1,j};
means for receiving by the cell_{i+1,j} the memory state c_{i,j} from the cell_{i,j};
means for computing, for the cell_{i+1,j}, a second partial value based on the received memory state c_{i,j};
means for receiving by the cell_{i+1,j} the hidden state h_{i,j} from the cell_{i,j};
means for computing, for the cell_{i+1,j}, a third partial value based on the received hidden state h_{i,j}; and
means for computing, for the cell_{i+1,j}, a memory state c_{i+1,j} based on the first partial value, the second partial value, and the third partial value.

24. The apparatus of claim 23, further comprising:
means for computing, for the cell_{i+1,j}, an input x_{i+1,j+1} based on the hidden state h_{i,j} and the input x_{i+1,j};
means for outputting, for the cell_{i+1,j}, the input x_{i+1,j+1} to a cell_{i+1,j+1};
means for receiving, for cell_{i,j+1} and for the cell_{i+1,j+1}, a memory state c_{i,j+1} and a hidden state h_{i,j+1;}
means for receiving, for cell_{i+1,j} and for the cell_{i+1,j+1}, the input x_{i+,j-1}; and
means for computing in parallel, for cell_{i+1,j+1}, an input x_{i+1,j+2} based on the hidden state h_{i,j+1} and the input x_{i+1,j+1}, and for the cell_{i+1,j}, a hidden state h_{i+1,j} based on the input x_{i+1,j+1} and the memory state c_{i+1,j}.

25. The apparatus of claim 24, further comprising:
means for outputting, for the cell_{i+1,j}, the memory state c_{i+1,j} and the hidden state h_{i+1,j} to the cell_{i+1,j};
means for receiving, for the cell_{i,j}, the memory state c_{i+1,j} and the hidden state h_{i+1,j};
means for re-computing, for the cell_{i,j}, the input x_{i,j+1}, the memory state c_{i,j}, and the hidden state hg based on the memory state c_{i+1,j} and the hidden state h_{i+1,j};
means for re-outputting, by the first processor for the cell_{i,j}, the input x_{i,j+1} to a cell_{i,j+1}; and
means for re-outputting, by the first processor for the cell_{i,j}, the memory state c_{i,j} and the hidden state h_{i,j} to the cell_{i+1,j}.

26. A computer readable medium storing computer executable code for operating a computational network, comprising code to:
compute, for a cell_{i,j}, an input x_{i,j+1} based on a hidden state h_{i-1,j} and an input x_{i,j};
compute, for the cell_{i,j}, a memory state c_{i,j} based on a memory state c_{i-1,j}, the hidden state h_{i-1,j}, and the input x_{i,j};
output, for the cell_{i,j}, the input x_{i,j+1} a cell_{i,j+1};
receive, by the cell_{i,j+1}, a memory state c_{i-1,j+1}, a hidden state h_{i-1,j+1}, and the input x_{i,j+1}; and
compute in parallel, for cell_{i,j+1}, an input x_{i,j+2} based on the hidden state h_{i-1,j+1} the input x_{i,j+1}, and by the first processor for the cell_{i,j}, a hidden state h_{i,j} based on the input x_{i,j+1} and the memory state c_{i,j}.

27. The computer readable medium of claim 26, further comprising code to compute the memory state c_{i,j} based on a first variable that is a function of the hidden state h_{i-1,j} and the input x_{i,j}, a second variable that is a function of the hidden state h_{i-1,j} and the input x_{i,j}, and a third variable that is a function of the hidden state h_{i-1,j} and the input x_{i,j}, wherein at least two of the first, second and third variables are computed in parallel.

28. The computer readable medium of claim 26, wherein each input x_{i,1} for 1≤i≤T is a pattern, and further comprising code to output for cell_{T,S} an inference of a next pattern that is determined based on the T patterns, where S is a number of different initial hidden states h_{0,j} and initial memory states c_{0,j} for 1≤j≤S.
